(19) United States
(12) Patent Application Publication
(10) Pub. No.: US 2025/0178576 A1
(43) Pub. Date: Jun. 5, 2025

(54) BRAKING CONTROL DEVICE FOR VEHICLE

(71) Applicant: ADVICS CO., LTD., Kariya-shi, Aichi-ken (JP)

(72) Inventor: Shunya WATANABE, Kariya-shi, Aichi-ken (JP)

(73) Assignee: ADVICS CO., LTD., Kariya-shi, Aichi-ken (JP)

(21) Appl. No.: 18/840,273

(22) PCT Filed: Mar. 10, 2023
(86) PCT No.: PCT/JP2023/009431

§ 371 Date: Aug. 21, 2024

(30) Foreign Application Priority Data
Mar. 10, 2022 (JP) 2022-036958

(51) Int. Cl. B60T 8/172; B60T 8/171; B60T 13/14; B60T 13/68; B60T 13/74

(52) U.S. Cl. CPC B60T 8/172; B60T 8/171; B60T 13/148; B60T 13/686; B60T 13/745; B60T 13/142; B60T 2220/04

(57) ABSTRACT

A braking control device includes a pressure adjustment unit that adjusts a wheel pressure Pw of a wheel cylinder by a servo pressure Pu generated using an electric motor as a power source, a solenoid valve provided in a hydraulic pressure transmission path from the servo pressure Pu to the wheel pressure Pw, and a controller that controls the pressure adjustment unit. The controller calculates a pressure loss Pd in the solenoid valve based on an instruction pressure Ps calculated from a braking request amount Bs and the wheel pressure Pw. Then, the controller determines a target pressure Pt by adding the pressure loss Pd to the instruction pressure Ps, and controls the pressure adjustment unit based on the target pressure Pt.

### TECHNICAL FIELD

The present disclosure relates to a braking control device for a vehicle.

### BACKGROUND ART

Patent Literature 1 describes a hydraulic pressure control unit that incorporates a concept of flow rate control and achieves both control accuracy and responsiveness of the hydraulic pressure control of a wheel brake. In Patent Literature 1, a controller obtains the target liquid amount of the wheel brake based on the target hydraulic pressure, and obtains the actual liquid amount of the wheel brake based on the hydraulic pressure detected by a brake hydraulic pressure detection means. Then, the target flow rate of the wheel brake is obtained based on the target liquid amount and the actual liquid amount, and the operation of the hydraulic pressure control unit is controlled based on the target flow rate.

The applicant has developed a braking control device as described in Patent Literature 2. The device of Patent Literature 2 includes two units, upper and lower fluid units. In the upper fluid unit, the braking fluid discharged from the fluid pump is adjusted to an adjustment hydraulic pressure (also referred to as “servo pressure”). Then, the servo pressure is transmitted as wheel pressure to a wheel cylinder via the lower fluid unit. The lower fluid unit includes a plurality of solenoid valves for controlling the wheel pressure independently for each wheel by anti-lock brake control, sideslip prevention control, and the like. When the servo pressure is transmitted as the wheel pressure from the upper fluid unit, the solenoid valve becomes a resistance, and the increase in the wheel pressure may be delayed. In order to cope with this, the braking control device is desired to improve the increase responsiveness of the wheel pressure.

### CITATIONS LIST

### Patent Literature

Patent Literature 1: JP 2008-296704 A
Patent Literature 2: JP 2019-059294 A

### SUMMARY

### Technical Problems

An object of the present disclosure is to provide a braking control device for a vehicle capable of improving the increase responsiveness of the wheel pressure.

### Solutions to Problems

A braking control device (SC) for a vehicle according to the present disclosure includes “a pressure adjustment unit (CA) that adjusts a wheel pressure (Pw) of a wheel cylinder (CW) by a servo pressure (Pu) generated by using an electric motor (MA) as a power source”, “a solenoid valve (e.g., inlet valve VI) provided in a hydraulic pressure transmission path (HS) from the servo pressure (Pu) to the wheel pressure (Pw)”, and “a controller (EA) that controls the pressure adjustment unit (CA)”.

In the braking control device (SC) for a vehicle according to the present disclosure, the controller (EA) calculates a pressure loss (Pd) in the solenoid valve (e.g., the inlet valve VI) based on an instruction pressure (Ps) calculated from a braking request amount (Bs) and the wheel pressure (Pw), determines a target pressure (Pt=Ps+Pd) by adding the pressure loss (Pd) to the instruction pressure (Ps), and controls the pressure adjustment unit (CA) based on the target pressure (Pt). For example, the controller (EA) calculates a predicted flow rate (Qy) passing through the solenoid valve (VI) based on a deviation (hRs) between an instruction liquid amount (Rs) calculated from the instruction pressure (Ps) and an actual liquid amount (Rw) calculated from the wheel pressure (Pw), and calculates the pressure loss (Pd) based on the predicted flow rate (Qy). According to the above configuration, since the target pressure Pt is determined in consideration of the pressure loss Pd by the solenoid valve, the increase responsiveness of the wheel pressure Pw is improved.

### BRIEF DESCRIPTION OF DRAWINGS

FIG. 1 is a schematic view for explaining an overall configuration of a vehicle JV equipped with a braking control device SC according to the present disclosure.

FIG. 2 is a schematic diagram for explaining a configuration example of an upper braking unit SA.

FIG. 3 is a schematic diagram for explaining a configuration example of a lower braking unit SB.

FIG. 4 is a flowchart for explaining a processing example of pressure adjusting control.

FIG. 5 is a block diagram for explaining calculation of a target pressure Pt.

FIG. 6 is a block diagram for explaining drive control of a pressure adjusting valve UA.

FIG. 7 is a block diagram for explaining drive control of an electric motor MA.

### DESCRIPTION OF EMBODIMENT

### <Symbols of Configuring Members, Etc., and Subscripts at the End of the Symbols>

In the following description, configuring members, calculation processes, signals, characteristics, and values having the same symbol such as “CW” have the same functions. The subscripts “f” and “r” attached to the end of the symbol related to each wheel are comprehensive symbols indicating which system of the front and rear wheels the subscripts relate to. For example, the wheel cylinders CW provided on the respective wheels are described as “front wheel cylinder CWf” and “rear wheel cylinder CWr”. Furthermore, the subscripts “f” and “r” at the end of the symbols can be omitted. When the subscripts “f” and “r” are omitted, each symbol represents a generic name. For example, “CW” is a generic term for wheel cylinders provided on front and rear wheels of a vehicle.

In the fluid path from a master cylinder CM to a wheel cylinder CW, the side close to the master cylinder CM (the side far from the wheel cylinder CW) is referred to as an “upper portion”, and the side close to the wheel cylinder CW (the side far from the master cylinder CM) is referred to as a “lower portion”. In addition, in the circulation flows KN and KL of the braking fluid BF, the side close to a discharge portion of fluid pumps QA and QB (the side away from a suction portion) is referred to as “upstream side”, and the side close to a suction portion of the fluid pumps QA and QB (the side away from the discharge portion) is referred to as “downstream side”.

An upper actuator YA (also referred to as “upper fluid unit”) of the upper braking unit SA, a lower actuator YB (also referred to as “lower fluid unit”) of the lower braking unit SB, and the wheel cylinder CW are connected by a fluid path (communication path HS). Furthermore, in the upper and lower actuators YA and YB, various components (UA etc.) are connected by a fluid path. Here, the “fluid path” is a path for moving the braking fluid BF, and corresponds to a pipe, a flow path in an actuator, a hose, and the like. In the following description, a communication path HS, a reflux path HK, a return path HL, a reservoir path HR, an input path HN, a servo path HV, a pressure reduction path HG, and the like are fluid paths.

<Vehicle JV Equipped with Braking Control Device SC>

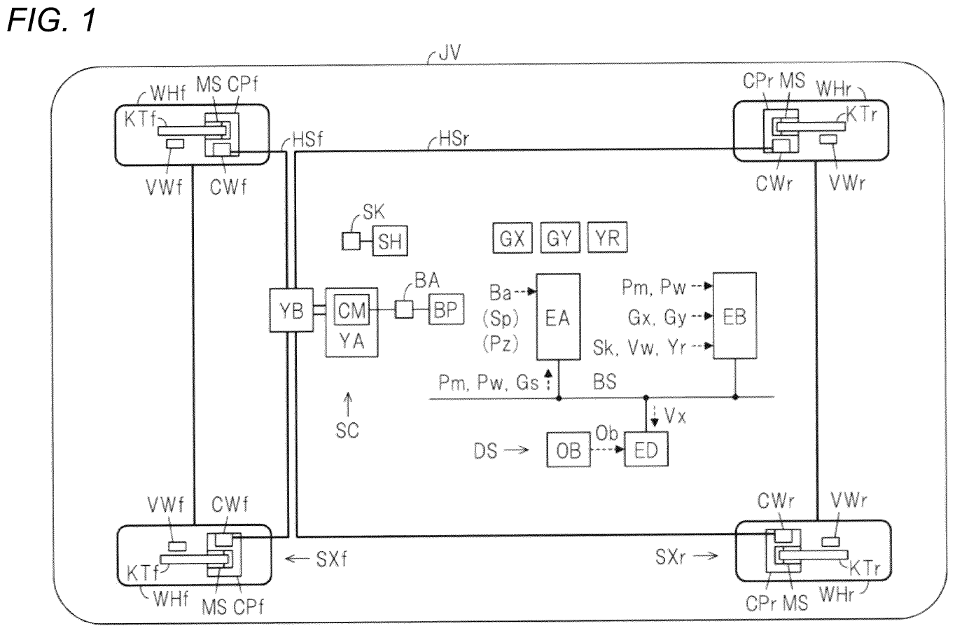

An overall configuration of a vehicle JV equipped with a braking control device SC according to the present disclosure will be described with reference to a schematic view of FIG. 1. The vehicle JV includes a driving assistance device DS such that control (referred to as “automatic braking control”) for automatically decelerating and stopping the vehicle via the braking control device SC is executed on behalf of or by assisting the driver. The driving assistance device DS includes a distance sensor OB and a control unit ED (also referred to as a “driving assistance controller”) for the driving assistance device. The distance sensor OB detects a distance Ob (relative distance) between an object (other vehicle, fixed object, person, bicycle, stop line, sign, signal, etc.) present in front of the own vehicle JV, and
the own vehicle JV and inputs the distance Ob to the driving assistance controller ED. In the driving assistance controller ED, a required deceleration Gs for automatically stopping the vehicle JV is calculated based on the relative distance Ob. The required deceleration Gs is a target value of the vehicle deceleration for executing the automatic braking control. The required deceleration Gs is output to the communication bus BS.

The vehicle JV includes front wheel and rear wheel braking devices SXf and SXr (=SX). The braking device SX includes a brake caliper CP, a friction member MS (e.g., a brake pad), and a rotating member KT (e.g., a brake disc). The brake caliper CP is provided with the wheel cylinder CW. The friction member MS is pressed against the rotating member KT fixed to each wheel WH by the hydraulic pressure Pw (referred to as “wheel pressure”) in the wheel cylinder CW. As a result, a friction braking force Fm is generated on the wheel WH. The “friction braking force Fm” is a braking force generated by the wheel pressure Pw.

The vehicle JV includes a braking operation member BP and a steering operation member SH. The braking operation member BP (e.g., a brake pedal) is a member operated by the driver to decelerate the vehicle JV. The steering operation member SH (e.g., the steering wheel) is a member operated by the driver to turn the vehicle JV.

The vehicle JV includes various sensors (BA etc.) listed below. Detection signals (Ba etc.) of these sensors are input to the controllers EA and EB and used for various controls.
A braking operation amount sensor BA that detects an operation amount Ba (referred to as a “braking operation amount”) of the braking operation member BP is provided. For example, an operation displacement sensor SP that detects the operation displacement Sp of the braking operation member BP is provided as the braking operation amount sensor BA. In addition, a simulator pressure sensor PZ that detects the hydraulic pressure Pz (referred to as “simulator pressure”) of the stroke simulator SS is adopted. In the braking control device SC, the braking operation amount Ba is a generic name of a signal representing a braking intention of the driver, and the braking operation amount sensor BA is a generic name of a sensor that detects the braking operation amount Ba. The braking operation amount Ba is input to the upper controller EA.
a wheel speed sensor VW that detects a rotational speed (wheel speed) Vw of the wheel WH is provided. The wheel speed Vw is input to the lower controller EB. The lower controller EB calculates the vehicle body speed Vx based on the wheel speed Vw. Furthermore, in the lower controller EB, anti-lock brake control for preventing locking of the wheels WH and traction control for preventing idling of the driving wheels WH are executed based on the wheel speed Vw and the vehicle body speed Vx.
A steering operation amount sensor SK that detects an operation amount Sk (a steering operation amount, for example, a steering angle) of the steering operation member SH is provided. The vehicle JV (In particular, the vehicle body) is provided with a yaw rate sensor YR that detects the yaw rate Yr, a longitudinal acceleration sensor GX that detects the longitudinal acceleration Gx, and a lateral acceleration sensor GY that detects the lateral acceleration Gy. These sensor signals are input to the lower controller EB. Then, in the lower controller EB, a sideslip prevention control (electronic stability control (ESC)) for suppressing oversteering and understeering and stabilizing yawing behavior of the vehicle JV is executed.

The vehicle JV includes a braking control device SC. In the braking control device SC, a front-rear type (also referred to as “type II”) is adopted as a two-system braking system. The actual wheel pressure Pw is adjusted by the braking control device SC.

The braking control device SC includes two braking units SA and SB. The upper braking unit SA is configured by an upper actuator YA (upper fluid unit) and an upper controller EA (upper control unit). The upper actuator YA is controlled by the upper controller EA. The lower braking unit SB is disposed between the upper braking unit SA and the wheel cylinder CW. The lower braking unit SB is configured by a lower actuator YB (lower fluid unit) and a lower controller EB (lower control unit). The lower actuator YB is controlled by the lower controller EB.

The upper braking unit SA (in particular, the upper controller EA), the lower braking unit SB (in particular, the lower controller EB), and the driving assistance device DS (in particular, the driving assistance controller ED) are connected to the communication bus BS. The “communication bus BS” has a network structure in which a plurality of controllers (control units) are suspended from a communication line. Signal transmission is carried out among the plurality of controllers (EA, EB, ED etc.) by the communication bus BS. That is, the plurality of controllers can transmit signals (detection value, calculation value, control flag, etc.) to the communication bus BS and receive signals from the communication bus BS.

### <Upper Braking Unit SA>

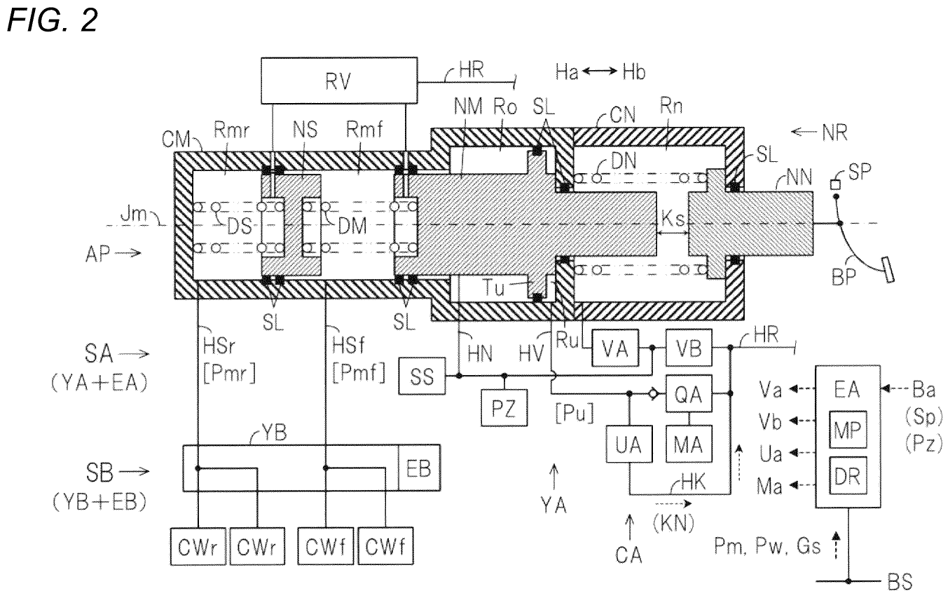

A configuration example of the upper braking unit SA of the braking control device SC will be described with reference to the schematic diagram of FIG. 2. The upper braking unit SA generates the supply pressure Pm in accordance with the operation of the braking operation member BP (brake pedal). The supply pressure Pm is eventually supplied to the wheel cylinder CW via the communication path HS (fluid path) and the lower braking unit SB. The upper braking unit SA is configured by the upper actuator YA and the upper controller EA.

### <<Upper Actuator YA>>

The upper actuator YA is configured by an apply unit AP, a pressure adjustment unit CA, and an input unit NR.

### [Apply Unit AP]

The supply pressure Pm is output from the apply unit AP according to the operation of the braking operation member BP. The apply unit AP is configured by a tandem type master cylinder CM, and primary and secondary master pistons NM and NS.

The primary and secondary master pistons NM and NS are inserted into the tandem type master cylinder CM. The inside of the master cylinder CM is divided into four hydraulic pressure chambers Rmf, Rmr, Ru, and Ro by the two master pistons NM and NS. The front wheel and rear wheel master chambers Rmf and Rmr (=Rm) are divided by the one-side bottom portion of the master cylinder CM and the master pistons NM and NS. Furthermore, the inside of the master cylinder CM is partitioned into a servo chamber Ru and a reaction force chamber Ro by a flange portion Tu of the master piston NM. The master chamber Rm and the servo chamber Ru are disposed so as to face each other with the flange portion Tu in between. These hydraulic pressure chambers Rmf, Rmr, Ru, and Ro are sealed by the seal member SL. Therefore, when the master pistons NM and NS are moved, frictional force is generated between the seal member SL and the sliding surface thereof. A pressure receiving area rm of the master chamber Rm is equal to a pressure receiving area ru of the servo chamber Ru.

At the time of non-braking, the master pistons NM and NS are at the most retracted positions (i.e., the position where the volume of the master chamber Rm is maximized). In this state, the master chamber Rm of the master cylinder CM communicates with the master reservoir RV. The braking fluid BF is stored inside the master reservoir RV (also referred to as “atmospheric pressure reservoir”). When the braking operation member BP is operated, the master pistons NM and NS are moved in the forward direction Ha (direction in which the volume of the master chamber Rm decreases). Communication between the master chamber Rm and the master reservoir RV is cut off by this movement. When the master pistons NM and NS are further moved in the forward direction Ha, the front wheel and rear wheel supply pressures Pmf and Pmr (=Pm) are increased from “0 (atmospheric pressure)”. As a result, the braking fluid BF pressurized to the supply pressure Pm is output (pressure-fed) from the master chamber Rm of the master cylinder CM. Since the supply pressure Pm is the hydraulic pressure of the master chamber Rm, it is also called “master pressure”.

### [Pressure Adjustment Unit CA]

The servo pressure Pu is supplied to the servo chamber Ru of the apply unit AP by the pressure adjustment unit CA. The pressure adjustment unit CA includes an upper electric motor MA, an upper fluid pump QA, and a pressure adjusting valve UA.

The upper electric motor MA (also simply referred to as an “electric motor”) drives the upper fluid pump QA (also simply referred to as a “fluid pump”). In the fluid pump QA, the suction portion and the discharge portion are connected by a reflux path HK (fluid path). The suction portion of the fluid pump QA is also connected to the master reservoir RV via the reservoir path HR. The discharge portion of the fluid pump QA is provided with a check valve.

The reflux path HK is provided with the normally-open pressure adjusting valve UA. The pressure adjusting valve UA is a linear type solenoid valve whose valve opening amount is continuously controlled based on an energized state (e.g., the supply current Ia). Since the pressure adjusting valve UA adjusts a hydraulic pressure difference (differential pressure) between the upstream side and the downstream side, it is also referred to as a “differential pressure valve”.

When the electric motor MA is driven and the braking fluid BF is discharged from the fluid pump QA, a circulation flow KN (indicated by a broken line arrow) of the braking fluid BF is generated in the reflux path HK. When the pressure adjusting valve UA is in the fully opened state (since the pressure adjusting valve UA is a normally-open type, at the time of non-energization), the hydraulic pressure Pu (referred to as “servo pressure”) between the discharge portion of the fluid pump QA and the pressure adjusting valve UA is “0 (atmospheric pressure)” in the reflux path HK. When the energization amount Ia (supply current) to the pressure adjusting valve UA is increased, the circulation flow KN (flow of the braking fluid BF circulating in the reflux path HK) is throttled by the pressure adjusting valve UA. In other words, the flow path of the reflux path HK is narrowed by the pressure adjusting valve UA, and the orifice effect by the pressure adjusting valve UA is exerted. As a result, the hydraulic pressure Pu on the upstream side of the pressure adjusting valve UA is increased from “0”. That is, in the circulation flow KN, a hydraulic pressure difference (differential pressure) between the hydraulic pressure Pu (servo pressure) on the upstream side and the hydraulic pressure (atmospheric pressure) on the downstream side is generated with respect to the pressure adjusting valve UA. The differential pressure is adjusted by the supply current Ia to the pressure adjusting valve UA.

The reflux path HK is connected to the servo chamber Ru via the servo path HV (fluid path) at a portion between the discharge portion (specifically, the downstream side portion of the check valve) of the fluid pump QA and the pressure adjusting valve UA. Therefore, the servo pressure Pu is introduced (supplied) to the servo chamber Ru. As the servo pressure Pu increases, the master pistons NM and NS are pressed in the forward direction Ha, and the hydraulic pressures Pmf and Pmr (front wheel and rear wheel supply pressure) in the front wheel and rear wheel master chambers Rmf and Rmr are increased.

Front wheel and rear wheel communication paths HSf and HSr (=HS) are connected to the front wheel and rear wheel master chambers Rmf and Rmr (=Rm). The front wheel and rear wheel communication paths HSf and HSr are connected to the front wheel and rear wheel cylinders CWf and CWr (=CW) via the lower braking unit SB (in particular, the lower actuator YB). Therefore, the front wheel and rear wheel supply pressures Pmf and Pmr are supplied from the upper braking unit SA to the front wheel and rear wheel cylinders CWf and CWr. Here, the front wheel supply pressure Pmf and the rear wheel supply pressure Pmr are equal (i.e., “Pmf=Pmr”).

### [Input Unit NR]

Although the braking operation member BP is operated by the input unit NR so as to realize the regenerative cooperative control, a state in which the wheel pressure Pw is not generated is generated. The “regenerative cooperative control” cooperates the friction braking force Fm (braking force by the wheel pressure Pw) and the regenerative braking force Fg (braking force by the motor/generator) so that kinetic energy of the vehicle JV can be efficiently recovered into electric energy by the motor/generator (not illustrated) at the time of braking. The input unit NR is configured by an input cylinder CN, an input piston NN, an introduction valve VA, an opening valve VB, a stroke simulator SS, and a simulator hydraulic pressure sensor PZ.

The input cylinder CN is fixed to the master cylinder CM. An input piston NN is inserted into the input cylinder CN. The input piston NN is mechanically connected to the braking operation member BP via a clevis (U-shaped link) so as to cooperatively operate with the braking operation member BP (brake pedal). The end surface of the input piston NN and the end surface of the primary piston NM have a gap Ks (also referred to as “separation displacement”). The regenerative cooperative control is realized by adjusting the separation distance Ks by the servo pressure Pu.

The input chamber Rn of the input unit NR is connected to the reaction force chamber Ro of the apply unit AP via an input path HN (fluid path). The input path HN is provided with a normally-closed introduction valve VA. The input path HN is connected to the master reservoir RV via the reservoir path HR between the introduction valve VA and the reaction force chamber Ro. The reservoir path HR is provided with a normally-open open valve VB. The introduction valve VA and the open valve VB are on/off type solenoid valves. A stroke simulator SS (also simply referred to as a “simulator”) is connected to the input path HN between the introduction valve VA and the reaction force chamber Ro.

When power supply (power supply) to the introduction valve VA and the open valve VB is not performed, the introduction valve VA is closed, and the open valve VB is opened. The input chamber Rn is sealed and fluidly locked by closing the introduction valve VA. As a result, the master pistons NM and NS are displaced integrally with the braking operation member BP. In addition, the simulator SS is communicated with the master reservoir RV by opening the open valve VB. When power supply (power supply) to the introduction valve VA and the open valve VB is performed, the introduction valve VA is opened, and the open valve VB is closed. As a result, the master pistons NM and NS can be displaced separately from the braking operation member BP. At this time, since the input chamber Rn is connected to the stroke simulator SS, the operation force Fp of the braking operation member BP is generated by the simulator SS. The input path HN is provided with a simulator pressure sensor PZ between the introduction valve VA and the reaction force chamber Ro so as to detect the hydraulic pressure Pz (simulator pressure) in the simulator SS. Note that since the simulator pressure Pz is also the internal pressure of the input chamber Rn, it is also a state quantity representing the operation force Fp of the braking operation member BP.

A state in which the master pistons NM and NS and the braking operation member BP are displaced separately (when solenoid valves VA, VB are energized) is referred to as a “first mode (or by-wire mode)”. In the first mode, the braking control device SC functions as a brake-by-wire type device (i.e., the device in which friction braking force Fm can be independently generated with respect to the braking operation of the driver). Therefore, in the first mode, the wheel pressure Pw is generated independently of the operation of the braking operation member BP. On the other hand, a state in which the master pistons NM and NS and the braking operation member BP are integrally displaced (when solenoid valves VA, VB are not energized) is referred to as a “second mode (or manual mode)”. In the second mode, the wheel pressure Pw is interlocked with the braking operation of the driver. In the input unit NR, one operation mode of the first mode (by-wire mode) and the second mode (manual mode) is selected depending on the presence or absence of power supply to the introduction valve VA and the open valve VB.

### <<Upper Controller EA>>

The upper controller EA controls the upper actuator YA. The upper controller EA is configured by a microprocessor MP and a drive circuit DR. The upper controller EA is connected to the communication bus BS so that a signal (detection value, calculation value, control flag, etc.) can be shared with other controllers (EB, ED, etc.).

The braking operation amount Ba is input to the upper controller EA. The braking operation amount Ba is a generic term for the state quantity representing the operation amount of the braking operation member BP. As the braking operation amount Ba, a detection signal Sp (operation displacement) of the operation displacement sensor SP and a detection signal Pz (simulator pressure) of the simulator pressure sensor PZ are directly input from the braking operation amount sensor BA to the upper controller EA. In addition, the supply pressure Pm, the wheel pressure Pw, the required deceleration Gs, and the like are input to the upper controller EA via the communication bus BS. “Supply pressure Pm” is an output pressure of the upper actuator YA. The supply pressure Pm is detected by a supply pressure sensor PM provided in the lower actuator YB and transmitted from the lower controller EB. The wheel pressure Pw is detected by a wheel pressure sensor PW provided in the lower actuator YB and transmitted from the lower controller EB. Alternatively, the wheel pressure Pw may be estimated by the upper controller EA. The required deceleration Gs is a target value of the automatic braking control, and is calculated by the driving assistance controller ED and transmitted from the driving assistance controller ED.

An algorithm of pressure adjusting control is programmed in the upper controller EA (in particular, the microprocessor MP). The “pressure adjusting control” is a control for adjusting the supply pressure Pm (eventually, the wheel pressure Pw). The pressure adjusting control is executed based on the braking operation amount Ba (operation displacement Sp, simulator pressure Pz), the required deceleration Gs, and the supply pressure Pm. Here, the braking operation amount Ba and the required deceleration Gs are collectively referred to as a “braking request amount Bs”. The braking request amount Bs is an input signal for instructing (requesting) the generation of the supply pressure Pm (as a result, the wheel pressure Pw to be generated by the braking control device SC).

The electric motor MA constituting the upper actuator YA and various solenoid valves (UA etc.) are driven by the drive circuit DR based on the algorithm of the pressure adjusting control. In the drive circuit DR, an H-bridge circuit is configured by switching elements (e.g., a MOS-FET) so as to drive the electric motor MA. In addition, the drive circuit DR includes a switching element so as to drive various solenoid valves (UA etc.). In addition, the drive circuit DR includes a motor current sensor (not illustrated) that detects a supply current Im (referred to as “motor current”) to the electric motor MA, and a pressure adjusting valve current sensor (not illustrated) that detects a supply current Ia (referred to as “pressure adjusting valve current”) to the pressure adjusting valve UA. Note that the electric motor MA is provided with a rotation angle sensor (not illustrated) that detects a rotation angle Ka (referred to as a “motor rotation angle”) of the rotor (rotor). Then, the motor rotation speed Na is calculated based on the motor rotation angle Ka.

In the upper controller EA, the target current It (target value) corresponding to the supply current Ia (actual value) is calculated based on the braking request amount Bs (Ba, Gs, etc.) of the vehicle. In the control of the pressure adjusting valve UA, the supply current Ia (pressure adjusting valve current) is controlled to approach and match the target current It. Furthermore, in the upper controller EA, the target rotation speed Nt (target value) corresponding to the motor rotation speed Na (actual value) is calculated based on the braking request amount Bs. In the control of the electric motor MA, the motor current Im is controlled such that the actual rotation speed Na approaches and matches the target rotation speed Nt. Specifically, if “Nt>Na”, the motor current Im is increased so that the motor rotation speed Na increases, and if “Nt<Na”, the motor current Im is decreased so that the motor rotation speed Na decreases. The drive signal Ma for controlling the electric motor MA and the drive signals Ua, Va, and Vb for controlling the various solenoid valves UA, VA, and VB are calculated based on these control algorithms. Then, the switching element of the drive circuit DR is driven according to the drive signal (Ma etc.), and the electric motor MA and the solenoid valves UA, VA, and VB are controlled.

### <Lower Braking Unit SB>

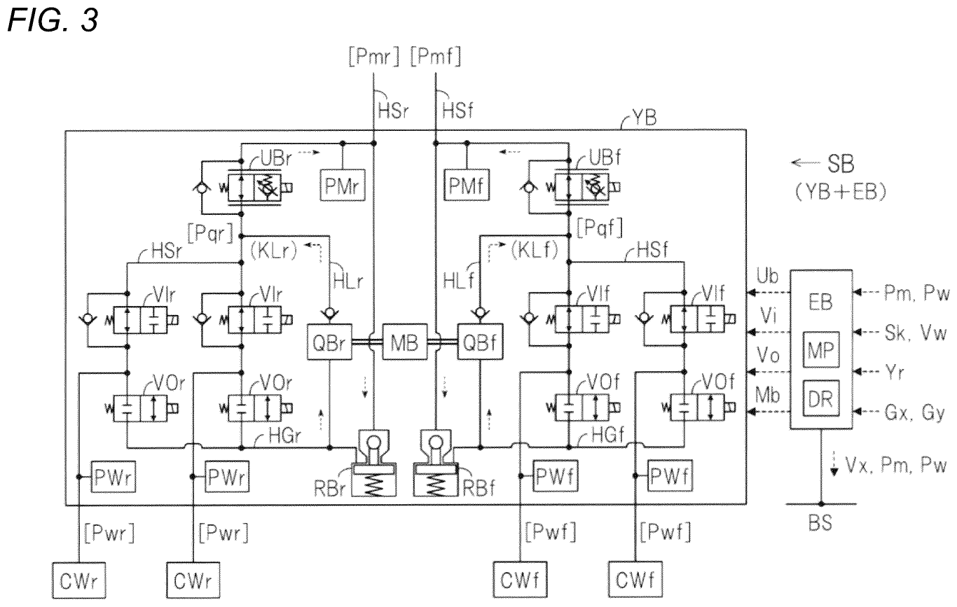

A configuration example of the lower braking unit SB of the braking control device SC will be described with reference to the schematic diagram of FIG. 3. The lower braking unit SB is a general-purpose unit (device) for executing anti-lock brake control, traction control, sideslip prevention control, and the like. In the anti-lock brake control, the traction control, the sideslip prevention control, and the like, the wheel pressure Pw of each wheel cylinder CW is independently adjusted, and thus, these are also collectively referred to as “each-wheel independent control”.

The front wheel and rear wheel supply pressures Pmf and Pmr (=Pm) are supplied from the upper braking unit SA to the lower braking unit SB. Then, the front wheel and rear wheel supply pressures Pmf and Pmr are adjusted (increased or decreased) by the lower braking unit SB, and are eventually output as the hydraulic pressures Pwf and Pwr (front-wheel and rear-wheel wheel pressures) of the front wheel and rear wheel cylinders CWf and CWr. The lower braking unit SB includes a lower actuator YB and a lower controller EB.

### <<Lower Actuator YB>>

The lower actuator YB is provided between the upper actuator YA and the wheel cylinder CW in the communication path HS. The lower actuator YB is configured by a supply pressure sensor PM, a wheel pressure sensor PW, a control valve UB, a lower fluid pump QB, a lower electric motor MB, a pressure adjusting reservoir RB, an inlet valve VI, and an outlet valve VO.

Front wheel and rear wheel control valves UBf and UBr (=UB) are provided on the front wheel and rear wheel communication paths HSf and HSr (=HS). Similarly to the pressure adjusting valve UA, the control valve UB is a normally open linear solenoid valve (differential pressure valve). The wheel pressure Pw can be individually increased in the front-rear wheel system from the supply pressure Pm by the control valve UB.

The front wheel and rear wheel supply pressure sensors PMf and PMr (=PM) are provided to detect the actual hydraulic pressures Pmf and Pmr (front wheel and rear wheel supply pressures) supplied from the upper actuator YA (in particular, front wheel and rear wheel master chambers Rmf, Rmr). The supply pressure sensor PM is also called a “master pressure sensor” and is built in the lower actuator YB. Signals of the front wheel and rear wheel supply pressures Pmf and Pmr (=Pm) are directly input to the lower controller EB and output to the communication bus BS. Note that since the front wheel supply pressure Pmf and the rear wheel supply pressure Pmr are substantially the same, any one of the front wheel and rear wheel supply pressure sensors PMf and PMr may be omitted. For example, in a configuration in which the rear wheel supply pressure sensor PMr is omitted, only the front wheel supply pressure Pmf is detected by the front wheel supply pressure sensor PMf.

The wheel pressure sensor PW is provided to detect the wheel pressure Pw, which is the actual hydraulic pressure of each wheel cylinder CW. The wheel pressure Pw is an output of the lower actuator YB. The wheel pressure sensor PW is built in the lower actuator YB. The signal of the wheel pressure Pw is directly input to the lower controller EB and output to the communication bus BS. When the anti-lock brake control or the like is not executed, the supply pressure Pm and the wheel pressure Pw are statically equal. Therefore, at least one wheel pressure sensor PW may be provided in the lower actuator YB, and the rest may be omitted. Alternatively, all the wheel pressure sensors PW may be omitted. In this configuration, as the wheel pressure Pw used for the pressure adjusting control, the supply pressure Pm or an estimated value calculated from the target pressure Pt is used.

Upper portions of the front wheel and rear wheel control valves UBf and UBr (a portion of the communication path HS on the side close to the upper actuator YA) and lower portions of the front wheel and rear wheel control valves UBf and UBr (a portion of the communication path HS on the side close to the wheel cylinder CW) are connected by the front wheel and rear wheel return paths HLf and HLr (=HL). The front wheel and rear wheel return paths HLf, HLr are provided with front wheel and rear wheel lower fluid pumps QBf, QBr (=QB) and front wheel and rear wheel pressure adjusting reservoirs RBf, RBr (=RB). The lower fluid pump QB is driven by the lower electric motor MB.

When the lower electric motor MB (also simply referred to as an “electric motor”) is driven, the braking fluid BF is sucked from the upper portion of the control valve UB and discharged to the lower portion of the control valve UB by the lower fluid pump QB (also simply referred to as a “fluid pump”). As a result, a circulation flow KL (i.e., the front wheel and rear wheel circulation flows KLf and KLr, indicated by broken line arrows) of the braking fluid BF including the fluid pump QB, the control valve UB, and the pressure adjusting reservoir RB is generated in the communication path HS and the return path HL. When the flow path of the communication path HS is narrowed by the control valve UB and the circulation flow KL of the braking fluid BF is throttled, the hydraulic pressure Pq (referred to as “adjusting pressure”) in the lower portion of the control valve UB is increased from the hydraulic pressure Pm (supply pressure) in the upper portion of the control valve UB by the orifice effect at that time. In other words, in the circulation flow KL, a hydraulic pressure difference (differential pressure) between the hydraulic pressure Pm (supply pressure) on the downstream side and the hydraulic pressure Pq (adjusting pressure) on the upstream side with respect to the control valve UB is adjusted by the control valve UB. Note that in the magnitude relationship between the supply pressure Pm and the adjusting pressure Pq, the adjusting pressure Pq is greater than or equal to the supply pressure Pm (i.e., “Pq>Pm”). As described above, the mechanism of generating the adjusting pressure Pq in the lower actuator YB is the same as the mechanism of generating the servo pressure Pu in the upper actuator YA.

Inside the lower actuator YB, the front wheel and rear wheel communication paths HSf and HSr are branched into two and connected to the front wheel and rear wheel cylinders CWf and CWr, respectively. In order to individually adjust each wheel pressure Pw, a normally-open inlet valve VI and a normally-closed outlet valve VO are provided for each wheel cylinder CW. Specifically, the inlet valve VI is provided in the branched communication path HS (i.e., the side closer to the wheel cylinder CW with respect to the branched portion of the communication path HS.). The communication path HS is connected to the pressure adjusting reservoir RB via a pressure reduction path HG (fluid path) at a lower portion of the inlet valve VI (a portion of the communication path HS on a side close to the wheel cylinder CW). The outlet valve VO is disposed in the pressure reduction path HG. An on/off type solenoid valve is employed as the inlet valve VI and the outlet valve VO. The wheel pressure Pw can be individually reduced from the adjusting pressure Pq (or, the supply pressure Pm) at each wheel by the inlet valve VI and the outlet valve VO. Accordingly, the each-wheel independent control (anti-lock brake control, sideslip prevention control, etc.) is executed.

When power is not supplied to the inlet valve VI and the outlet valve VO and their operations are stopped, the inlet valve VI is opened and the outlet valve VO is closed. In this state, the wheel pressure Pw is equal to the adjusting pressure Pq. The wheel pressure Pw is independently adjusted for each wheel cylinder CW by driving the inlet valve VI and the outlet valve VO. In order to reduce the wheel pressure Pw, the inlet valve VI is closed and the outlet valve VO is opened. Since the inflow of the braking fluid BF into the wheel cylinder CW is inhibited and the braking fluid BF in the wheel cylinder CW flows out to the pressure adjusting reservoir RB, the wheel pressure Pw is reduced. In order to increase the wheel pressure Pw, the inlet valve VI is opened and the outlet valve VO is closed. Since the outflow of the braking fluid BF to the pressure adjusting reservoir RB is inhibited and the adjusting pressure Pq from the pressure adjusting valve UB is supplied to the wheel cylinder CW, the wheel pressure Pw is increased. Here, the upper limit of the increase in the wheel pressure Pw is the adjusting pressure Pq. In order to maintain the wheel pressure Pw, both the inlet valve VI and the outlet valve VO are closed. Since the wheel cylinder CW is fluidly sealed, the wheel pressure Pw is maintained constant.

### <<Lower Controller EB>>

The lower controller EB controls the lower actuator YB. Similarly to the upper controller EA, the lower controller EB is configured by a microprocessor MP and a drive circuit DR. Since the lower controller EB is connected to the communication bus BS, the upper controller EA and the lower controller EB can share signals via the communication bus BS.

The wheel speed Vw, the steering operation amount Sk, the yaw rate Yr, the longitudinal acceleration Gx, and the lateral acceleration Gy are input to the lower controller EB (in particular, the microprocessor MP). The lower controller EB calculates the vehicle body speed Vx based on the wheel speed Vw. The lower controller EB executes each wheel independent. Specifically, as each wheel independent, anti-lock brake control (ABS control) for suppressing locking of the wheel WH, traction control for suppressing idling of the driving wheel, and sideslip prevention control (ESC) for suppressing understeering and oversteering to improve directional stability of the vehicle are executed.

The lower controller EB drives the lower electric motor MB constituting the lower actuator YB and various solenoid valves (UB etc.). In the drive circuit DR of the lower controller EB, an H-bridge circuit is configured by switching elements (e.g., a MOS-FET) so as to drive the lower electric motor MB. In addition, the drive circuit DR includes a switching element so as to drive various solenoid valves (UB etc.). The drive signal Ub of the control valve UB, the drive signal Vi of the inlet valve VI, the drive signal Vo of the outlet valve VO, and the drive signal Mb of the lower electric motor MB are calculated based on a control algorithm programmed in the microprocessor MP. Then, the lower electric motor MB and the solenoid valves UB, VI, and VO are controlled by the drive circuit DR based on the drive signal (Ub, etc.).

### <Pressure Adjusting Control Process>

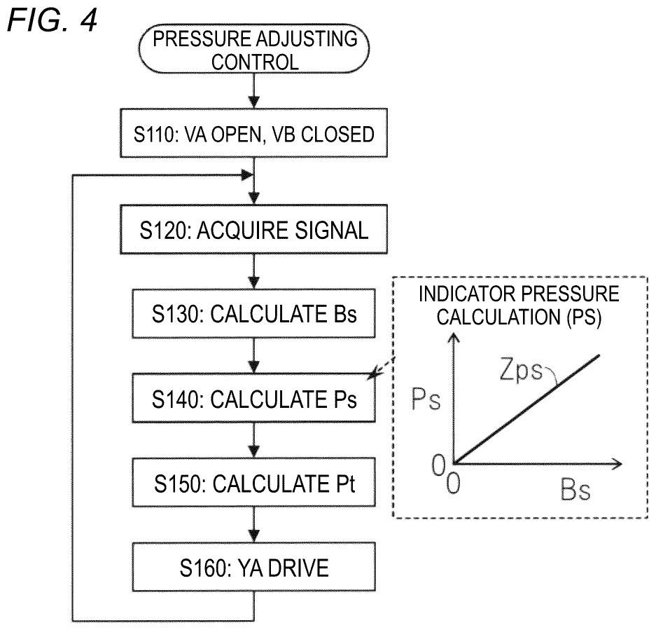

A process of pressure adjusting control will be described with reference to a flowchart of FIG. 4. The pressure adjusting control is control of the supply pressure Pm (as a result, the wheel pressure Pw) based on the braking request amount Bs (Ba, Gs, etc.) of the vehicle. An algorithm of the pressure adjusting control is programmed in the microprocessor MP of the upper controller EA.

In the description of the processing example, the following is assumed.
In the pressure adjusting control, the lower actuator YB is not driven, and only the upper actuator YA is driven. Therefore, since the wheel pressure Pw is adjusted only by the upper actuator YA, the wheel pressure Pw and the supply pressure Pm statically (constantly) match (i.e., “Pm=Pw”). However, since the pressure loss Pd dynamically occurs in the control valve UB in the lower actuator YB and the inlet valve VI, the wheel pressure Pw is smaller than the supply pressure Pm (i.e., “Pm>Pw”).
In the upper actuator YA, the pressure receiving area rm (also referred to as “master area”) of the master chamber Rm and the pressure receiving area ru (also referred to as “servo area”) of the servo chamber Ru are set equal. Therefore, “rm=ru”, and in the static state, “Pm=Pu” (here, the frictional resistance of the seal member SL is ignored).
The supply pressure sensor PM is built in the lower actuator YB. The upper controller EA acquires the supply pressure Pm from the lower controller EB via the communication bus BS.
In the lower actuator YB, the rear wheel supply pressure sensor PMr is omitted, and only the front wheel supply pressure sensor PMf is provided as the supply pressure sensor PM. Therefore, only the front wheel supply pressure Pmf is adopted as the signal of the supply pressure Pm.

In step S110, power is supplied to the introduction valve VA and the open valve VB by the upper controller EA. As a result, the normally-closed introduction valve VA is opened, the normally-opened open valve VB is closed, and the first mode in which the master pistons NM and NS and the braking operation member BP can be displaced as separate bodies is selected. In the first mode, the supply pressure Pm (i.e., the wheel pressure Pw) is adjusted independently of the operation of the braking operation member BP. At this time, the operation force Fp of the braking operation member BP is generated by the stroke simulator SS.

In step S120, various signals (Ba etc.) are read. The braking operation amount Ba (Sp, Pz, etc.) is detected by the braking operation amount BA (SP, PZ, etc.) and input to the upper controller EA. The required deceleration Gs is obtained from the driving assistance controller ED via the communication bus BS. The supply pressure Pm and the wheel pressure Pw are acquired from the lower controller EB via the communication bus BS.

In step S130, the braking request amount Bs is calculated based on the braking operation amount Ba and the required deceleration Gs. For example, the braking operation amount Ba and the required deceleration Gs are compared in the dimension of the vehicle deceleration, and the larger one of them is determined as the braking request amount Bs. The braking request amount Bs is an instruction value for the supply pressure Pm (=Pw) requested to the braking control device SC.

In step S140, the instruction pressure Ps is calculated based on the braking request amount Bs and the calculation map Zps set in advance. The “instruction pressure Ps” is a target value corresponding to the supply pressure Pm, and is an intermediate target value for calculating the target pressure Pt which is a final target value. The instruction pressure Ps is calculated so as to increase according to the calculation map Zps as the braking request amount Bs increases.

In step S150, the target pressure Pt is calculated based on the instruction pressure Ps. The “target pressure Pt” is a final target value corresponding to the supply pressure Pm (as a result, the wheel pressure Pw). In the pressure adjusting control, when the servo pressure Pu from the upper braking unit SA is transmitted as the wheel pressure Pw of the wheel cylinder CW via the lower braking unit SB, movement (i.e., the flow of the braking fluid BF) of the brake fluid BF from the upper braking unit SA to the wheel cylinder CW occurs. At this time, power is not supplied to the normally-open solenoid valves UB and VI provided in the lower actuator YB, and these valves are opened. The valve opening amounts of the solenoid valves UB and VI are limited. Even when the solenoid valves UB and VI are in the fully opened state, the flow path (i.e., the communication path HS) of the braking fluid BF is narrowed, and the braking fluid BF is less likely to flow. That is, since the solenoid valves UB and VI become a resistance, energy loss occurs. As a result, in the lower portions (i.e., the side of the wheel cylinder CW) of the solenoid valves UB and VI, the hydraulic pressure lowers with respect to the upper portion (i.e., the side of the upper braking unit SA). This lowering in hydraulic pressure is called “pressure loss Pd”. In other words, the pressure loss Pd occurs due to the energy loss when the braking fluid BF passes through the solenoid valves UB and VI. In step S150, a pressure loss Pd is anticipated with respect to the instruction pressure Ps, and the target pressure Pt is calculated. Specifically, the sum of the instruction pressure Ps and the pressure loss Pd is determined as the target pressure Pt (i.e., “Pt=Ps+Pd”). A method of calculating the pressure loss Pd will be described later.

In step S160, the upper controller EA controls the upper actuator YA (in particular, the pressure adjustment unit CA) so that the supply pressure Pm (actual value) approaches and matches the target pressure Pt (target value). Specifically, the upper electric motor MA is driven, and the braking fluid BF is discharged from the upper fluid pump QA. As a result, a circulation flow KN (also referred to as an “upper circulation flow”) of the braking fluid BF is generated in the reflux path HK. Then, the pressure adjusting valve UA is driven and the circulation flow KN is throttled, thereby generating the servo pressure Pu. In the driving of the upper actuator YA, the pressure adjusting valve UA is controlled by feedback control based on the supply pressure Pm so that the supply pressure Pm approaches the target pressure Pt. Since the driving of the lower actuator YB is stopped, the wheel pressure Pw matches the supply pressure Pm.

### <Calculation Processing of Target Pressure Pt>

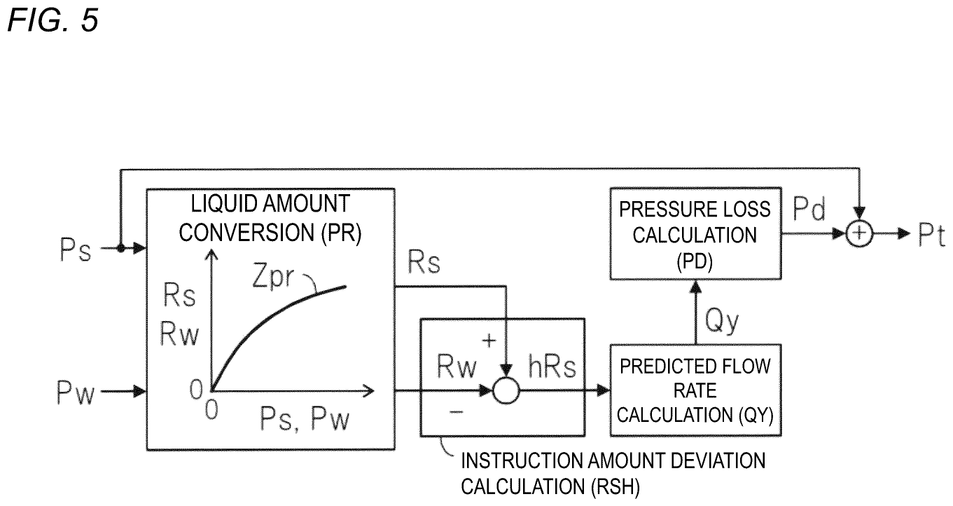

The calculation process (on particular, the process of step S150) of the target pressure Pt will be described with reference to the block diagram of FIG. 5. As described above, when the wheel pressure Pw is increased, the braking fluid BF flows from the upper actuator YA toward the wheel cylinder CW. At this time, since the flow path is narrowed by the solenoid valves UB and VI constituting the lower actuator YB, the braking fluid BF is less likely to flow. Since the solenoid valves UB and VI become a resistance, the wheel pressure Pw decreases from the supply pressure Pm. As described above, the pressure loss Pd occurs in the lower actuator YB, but the target pressure Pt is a target value in which the influence of the pressure loss Pd is considered. The calculation process of the target pressure Pt includes a liquid amount conversion block PR, an instruction amount deviation calculation block RSH, a predicted flow rate calculation block QY, and a pressure loss calculation block PD.

In the liquid amount conversion block PR, the instruction liquid amount Rs and the actual liquid amount Rw are calculated based on the instruction pressure Ps, the wheel pressure Pw, and the calculation map Zpr set in advance. Here, the instruction pressure Ps is an intermediate target value calculated based on the braking request amount Bs for the vehicle. Specifically, the instruction pressure Ps is determined so as to increase as the braking request amount Bs increases. Furthermore, the wheel pressure Pw is a detection value of the wheel pressure sensor PW. Alternatively, the wheel pressure Pw may be an estimated value. The wheel pressure Pw depends on the amount (volume, also simply referred to as “liquid amount”) of the braking fluid BF flowing into the wheel cylinder CW. The relationship between the inflow amount (liquid amount) of the braking fluid BF and the wheel pressure Pw is based on the rigidity (e.g., rigidity of the brake caliper CP, the brake pad MS, etc.) of the braking device SX.

In the liquid amount conversion block PR, the relationship of the liquid amount with respect to the hydraulic pressure is set in advance as the calculation map Zpr. In the liquid amount conversion block PR, the instruction pressure Ps is converted into the instruction liquid amount Rs, and the wheel pressure Pw is converted into the actual liquid amount Rw according to the calculation map Zpr. The instruction liquid amount Rs is a liquid amount necessary for achieving the instruction pressure Ps. Furthermore, the actual liquid amount Rw is a liquid amount already flowing into the wheel cylinder CW in order to generate the wheel pressure Pw (actual value or estimated value). Therefore, the instruction liquid amount Rs is a target value of the liquid amount calculated based on the instruction pressure Ps, and the actual liquid amount Rw is an actual value of the liquid amount calculated based on the wheel pressure Pw.

In the instruction amount deviation calculation block RSH, a deviation hRs (referred to as “instruction amount deviation”) between the instruction liquid amount Rs and the actual liquid amount Rw is calculated. Specifically, the actual liquid amount Rw is subtracted from the instruction liquid amount Rs to determine the instruction amount deviation hRs (i.e., “hRs=Rs-Rw”). The “instruction amount deviation hRs” is a target value of the liquid amount to be flowed into the wheel cylinder CW in the future in order to achieve the instruction pressure Ps.

In the predicted flow rate calculation block QY, the predicted flow rate Qy is calculated based on the instruction amount deviation hRs. The “predicted flow rate Qy” is a value obtained by predicting the flow rate (passing liquid amount per unit time) of the braking fluid BF passing through the solenoid valves UB and VI.

Specifically, in the predicted flow rate calculation block QY, the instruction amount deviation hRs is time-differentiated to determine the predicted flow rate Qy (predicted value) (i.e., “Qy=d (hRs)/dt”).

In the pressure loss calculation block PD, the pressure loss Pd generated in the solenoid valves UB and VI is calculated based on the predicted flow rate Qy. Specifically, the solenoid valves UB, VI are considered as synthesis orifices. Then, using the flow rate coefficient C of the synthesis orifice and the orifice area A, the pressure loss Pd is determined by the following equation (1).

Pd={Qy/(C·A)}\hat{ }2 Equation (1)

According to equation (1), the pressure loss Pd is calculated so as to increase as the predicted flow rate Qy increases.

The target pressure Pt is calculated based on the instruction pressure Ps and the pressure loss Pd. Specifically, the target pressure Pt is determined by adding the pressure loss Pd to the instruction pressure Ps so as to compensate for the influence of the pressure loss Pd (i.e., “Pt=Ps+Pd”). Note that since the flow rate coefficient C changes according to the viscosity of the braking fluid BF, the flow rate coefficient C corresponding to the temperature Tb of the braking fluid BF may be adopted in the calculation of the pressure loss Pd. Specifically, since the viscosity decreases as the temperature Tb of the braking fluid BF decreases, the pressure loss Pd is determined to increase as the temperature Tb decreases. Here, the temperature Tb is detected by a liquid temperature sensor (not illustrated). Alternatively, it may be estimated based on a detection value of an outside air temperature sensor (not illustrated).

The calculation process of the target pressure Pt will be summarized. The flow rate Qy (predicted flow rate) of the braking fluid BF passing through the control valve UB and the inlet valve VI is calculated based on the “instruction pressure Ps calculated based on the braking request amount Bs” and the “actual wheel pressure Pw”. This is based on the fact that since the opening area A when the solenoid valves UB and VI are considered as orifices is known, the pressure loss Pd can be calculated based on the predicted flow rate Qy. The pressure loss Pd is determined to increase as the predicted flow rate Qy increases (specifically, in proportion to the square of the predicted flow rate Qy). The target pressure Pt is calculated by adding the predicted pressure loss Pd to the instruction pressure Ps. That is, the hydraulic pressure Pd corresponding to the pressure loss is anticipated in advance at the target pressure Pt. Therefore, when the braking request amount Bs is rapidly increased (i.e., when the predicted flow rate Qy is large), a response delay (i.e., the delay of the pressure increase) of the wheel pressure Pw is suppressed.

The pressure loss Pd becomes a problem when the hydraulic pressure (Pu, Pm, Pw, etc.) is increased (referred to as “time of pressure increase”) as the braking request amount Bs is increased. Therefore, the calculation of the target pressure Pt based on the pressure loss Pd may be executed only at the time of pressure increase. For example, when the braking request amount Bs is maintained constant and the hydraulic pressure (Pu, Pm, Pw, etc.) is constant (referred to as “steady state”), the instruction pressure Ps and the wheel pressure Pw become equal, so that the predicted flow rate Qy is “0”. Therefore, since no pressure loss Pd occurs, “Pd=0” is determined. Furthermore, when the braking request amount Bs is decreased and the hydraulic pressure (Pu, Pm, Pw, etc.) is decreased (referred to as “time of pressure decrease”), the instruction pressure Ps is smaller than the wheel pressure Pw, so that the pressure loss Pd is calculated to a negative value but is determined as “Pd=0”.

### <Drive Control of Pressure Adjusting Valve UA>

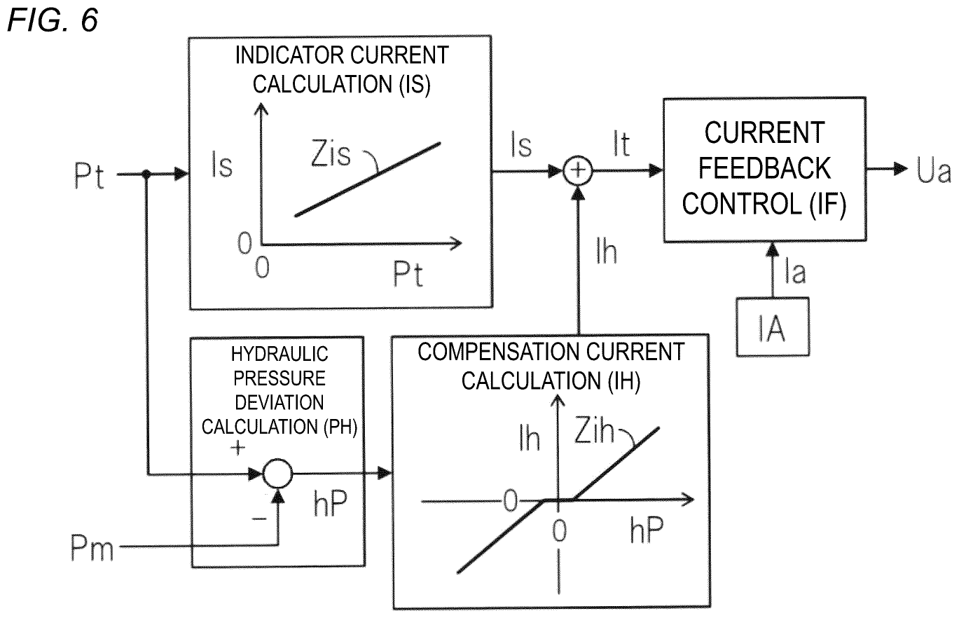

A process example of the drive control of the pressure adjusting valve UA (in particular, the process of step S160) will be described with reference to the block diagram of FIG. 6. The process is executed by the upper controller EA. The servo pressure Pu is adjusted by the pressure adjusting valve UA, and eventually, the supply pressure Pm (=Pw) is adjusted. The drive control of the pressure adjusting valve UA includes an instruction current calculation block IS, a hydraulic pressure deviation calculation block PH, a compensation current calculation block IH, and a current feedback control block IF.

In the instruction current calculation block IS, the instruction current Is is calculated based on the target pressure Pt and the calculation map Zis set in advance. The “instruction current Is” is a target value corresponding to the supply current Ia (actual value) of the pressure adjusting valve UA necessary for achieving the target pressure Pt. The instruction current Is is determined to increase according to the calculation map Zis as the target pressure Pt increases. The instruction current calculation block IS corresponds to feedforward control based on the target pressure Pt.

In the hydraulic pressure deviation calculation block PH, a deviation hP (hydraulic pressure deviation) between the target pressure Pt and the supply pressure Pm is calculated. Specifically, the supply pressure Pm is subtracted from the target pressure Pt to determine the hydraulic pressure deviation hP (i.e., “hP=Pt−Pm”).

In the compensation current calculation block IH, the compensation current Ih is calculated based on the hydraulic pressure deviation hP and the preset calculation map Zih. The instruction current Is is calculated in accordance with the target pressure Pt, but an error may occur between the target pressure Pt and the supply pressure Pm. The “compensation current Ih” is for compensating (reducing) this error. The compensation current Ih is determined to increase as the hydraulic pressure deviation hP increases according to the calculation map Zih. Specifically, when the target pressure Pt is larger than the supply pressure Pm and the hydraulic pressure deviation hP has a positive sign, the compensation current Ih of the positive sign is determined so that the instruction current Is is increased. On the other hand, when the target pressure Pt is smaller than the supply pressure Pm and the hydraulic pressure deviation hP has a negative sign, the compensation current Ih of the negative sign is determined so that the instruction current Is is decreased. Here, a dead zone is provided in the calculation map Zih. Furthermore, the compensation current calculation block IH corresponds to feedback control based on the supply pressure Pm.

The compensation current Ih is added to the instruction current Is, and the target current It is calculated (i.e., “It=Is+Ih”). The “target current It” is a final target value of the current supplied to the pressure adjusting valve UA. That is, the target current It is determined as the sum of the instruction current Is, which is the feedforward term, and the compensation current Ih, which is the feedback term. Therefore, the drive control of the pressure adjusting valve UA is configured by feedforward control (process of the instruction current calculation block IS) and feedback control (process of the compensation current calculation block IH) in the hydraulic pressure.

In the current feedback control block IF, the drive signal Ua is calculated based on the target current It (target value) and the supply current Ia (actual value) such that the supply current Ia approaches and matches the target current It. Here, the supply current Ia is detected by a pressure adjusting valve current sensor IA provided in the drive circuit DR. In the current feedback control block IF, if “It>Ia”, the drive signal Ua is determined such that the supply current Ia increases. On the other hand, if “It<Ia”, the drive signal Ua is determined such that the supply current Ia decreases. That is, in the current feedback control block IF, feedback control related to the current is executed. Therefore, the drive control of the pressure adjusting valve UA includes feedback control related to the current in addition to feedback control related to the hydraulic pressure.

### <Drive Control of Electric Motor MA>

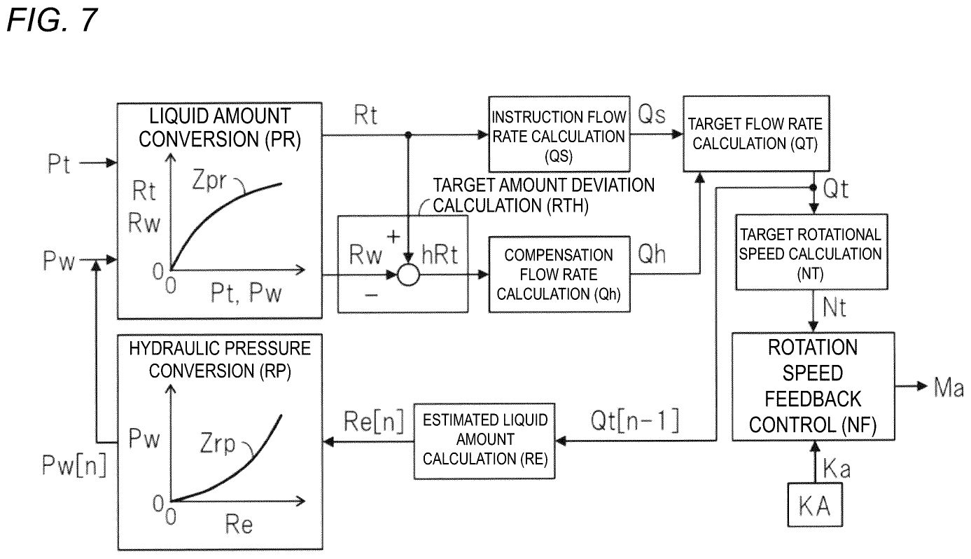

A processing example (in particular, the process of step S160) of the drive control of the upper electric motor MA will be described with reference to the block diagram of FIG. 7. The process is executed by the upper controller EA. The electric motor MA is controlled based on the flow rate of the braking fluid BF so as to reduce the power consumption. The drive control of the electric motor MA includes a liquid amount conversion block PR, a target amount deviation calculation block RTH, an instruction flow rate calculation block QS, a compensation flow rate calculation block QH, a target flow rate calculation block QT, a target rotation speed calculation block NT, and a rotation speed feedback control block NF.

In the liquid amount conversion block PR, the target liquid amount Rt and the actual liquid amount Rw are calculated based on the target pressure Pt and the wheel pressure Pw. As described with reference to FIG. 5, in the liquid amount conversion block PR, the target pressure Pt is converted into the target liquid amount Rt and the wheel pressure Pw is converted into the actual liquid amount Rw based on the preset calculation map Zpr. Here, the target liquid amount Rt is a liquid amount necessary for achieving the target pressure Pt (volume of the braking fluid BF to be moved to the wheel cylinder CW). Furthermore, the actual liquid amount Rw is a liquid amount already flowed into the wheel cylinder CW in order to generate the wheel pressure Pw.

In the target amount deviation calculation block RTH, a deviation hRt (referred to as “target amount deviation”) between the target liquid amount Rt and the actual liquid amount Rw is calculated. Specifically, the actual liquid amount Rw is subtracted from the target liquid amount Rt to determine the target amount deviation hRt (i.e., “hRt=Rt-Rw”). In the target liquid amount Rt, a hydraulic pressure portion Pd corresponding to the pressure loss is anticipated. Therefore, the “target amount deviation hRt” is a target value of the liquid amount (volume) to be flowed into the wheel cylinder CW in the future in order to achieve the target pressure Pt in which the pressure loss Pd is taken into consideration.

In the instruction flow rate calculation block QS, the instruction flow rate Qs is calculated based on the target liquid amount Rt. Specifically, the target liquid amount Rt is time-differentiated to determine the instruction flow rate Qs (i.e., “Qs=dRt/dt”). The instruction flow rate calculation block QS corresponds to feedforward control based on the flow rate control.

In the compensation flow rate calculation block QH, the compensation flow rate Qh is calculated based on the target amount deviation hRt. Specifically, the target amount deviation hRt is time-differentiated to determine the compensation flow rate Qh (i.e., “Qh=d (hRt)/dt”). The compensation flow rate calculation block QH corresponds to the feedback control in the flow rate control.

In the target flow rate calculation block QT, the target flow rate Qt is calculated based on the instruction flow rate Qs and the compensation flow rate Qh. The “target flow rate Qt” is a final target value of the flow rate necessary for achieving the target pressure Pt. Specifically, the target flow rate Qt is determined by adding the instruction flow rate Qs and the compensation flow rate Qh (i.e., “Qt=Qs+Qh”). That is, the target flow rate Qt is calculated as the sum of the instruction flow rate Qs corresponding to the feedforward term and the compensation flow rate Qh corresponding to the feedback term. In other words, the flow rate control includes feedforward control (process of the instruction flow rate calculation block QS) and feedback control (process of the compensation flow rate calculation block QH).

In the target rotation speed calculation block NT, the target rotation speed Nt of the electric motor MA is calculated based on the target flow rate Qt. The “target rotation speed Nt” is a target value corresponding to the rotation speed Na (actual value) of the electric motor MA. Specifically, based on the discharge amount of the fluid pump QA (the volume of the braking fluid BF discharged per rotation), the target rotation speed Nt is determined to increase in accordance with an increase in the target flow rate Qt. The target rotation speed Nt is determined in consideration of the minimum flow rate of the pressure adjusting valve UA and the minimum rotation speed of the electric motor MA. The “minimum flow rate” is a minimum necessary flow rate for the pressure adjusting valve UA to adjust the servo pressure Pu, and is set in advance. Furthermore, the “minimum rotation speed” is the minimum value of the rotation speed at which the electric motor MA continues to rotate stably. In consideration of these, the target rotation speed Nt is provided with the lower limit rotation speed nt (predetermined value set in advance). Therefore, when the target rotation speed Nt calculated based on the target flow rate Qt is greater than or equal to the lower limit rotation speed nt, the limit by the lower limit rotation speed nt is not performed, and the calculated target rotation speed Nt is used as it is. On the other hand, when the target rotation speed Nt calculated based on the target flow rate Qt is less than the lower limit rotation speed nt, the target rotation speed Nt is determined to be the lower limit rotation speed nt (i.e., “Nt=nt”).

In the rotation speed feedback control block NF, the drive signal Ma is calculated based on the target rotation speed Nt (target value) and the actual rotation speed Na (actual value) such that the actual rotation speed Na approaches and matches the target rotation speed Nt. Here, the actual rotation speed Na is calculated based on the detection value Ka (rotation angle) of the rotation angle sensor KA provided in the electric motor MA. Specifically, the motor rotation angle Ka is time-differentiated to determine the motor rotation speed Na. In the rotation speed feedback control block NF, if “Nt>Na”, the drive signal Ma is determined such that the actual rotation speed Na increases. On the other hand, if “Nt<Na”, the drive signal Ma is determined such that the actual rotation speed Na decreases. That is, in the rotation speed feedback control block NF, feedback control related to the motor rotation speed is executed.

The wheel pressure Pw is detected by the wheel pressure sensor PW, but the wheel pressure Pw may be estimated. In this configuration, all the wheel pressure sensors PW are omitted. Hereinafter, a method of estimating the wheel pressure Pw will be described. In order to estimate the wheel pressure Pw, in addition to the above configuration, an estimated liquid amount calculation block RE and a hydraulic pressure conversion block RP are provided.

In the estimated liquid amount calculation block RE, the estimated liquid amount Re is calculated based on the target flow rate Qt. Specifically, in the calculation cycle, the previous value Qt[n−1] of the target flow rate Qt is time-integrated to determine the present value Re[n] of the estimated liquid amount Re (i.e., “Re[n]=∫Qt[n−1]·dt”). Here, [ ] represents a calculation cycle, “n−1” represents a previous calculation value, and “n” represents a present calculation value.

In the hydraulic pressure conversion block RP, the present value Pw[n] of the wheel pressure Pw is calculated based on the present value Re[n] of the estimated liquid amount Re. In the hydraulic pressure conversion block RP, a relationship of the hydraulic pressure with respect to the liquid amount is set in advance as a calculation map Zrp. In the hydraulic pressure conversion block RP, the estimated liquid amount Re is converted into the wheel pressure Pw based on the calculation map Zrp. Note that the calculation map Zpr and the calculation map Zrp are in a reverse relationship (i.e., a relationship of an inverse function in which the X axis and the Y axis are interchanged).

In the braking control device SC, the rotation speed Na of the electric motor MA is controlled based on the target flow rate Qt calculated from the target pressure Pt. That is, in the control of the electric motor MA, a necessary and minimum flow rate is determined from the viewpoint of the flow rate of the braking fluid BF, and the electric motor MA is controlled based thereon. Therefore, the power consumed by the electric motor MA is suppressed.

In the braking control device SC, the target flow rate Qt is calculated based on the target pressure Pt and the wheel pressure Pw. In the calculation cycle, the present value Pw[n] of the wheel pressure Pw is estimated based on the previous value Qt[n−1] of the target flow rate Qt. Since the wheel pressure sensor PW is omitted by the estimation calculation, the device is simplified.

### OTHER EMBODIMENTS

Other embodiments will be described below. In other embodiments as well, the effects similar to the above (improvement in responsiveness of the wheel pressure Pw, etc.) are obtained.

In the above-described embodiment, the target flow rate Qt is calculated based on the target pressure Pt and the wheel pressure Pw, and the present value Pw[n] of the wheel pressure Pw is estimated based on the previous value Qt[n−1] of the target flow rate Qt. Instead, the actual flow rate Qw corresponding to the target flow rate Qt may be calculated based on the supply pressure Pm, and the present value Pw[n] of the wheel pressure Pw may be estimated based on the previous value Qw[n−1] of the actual flow rate Qw. Also in this configuration, similarly to the case where the target flow rate Qt is adopted, the previous value Qw[n−1] of the actual flow rate Qw calculated from the supply pressure Pm is time-integrated to calculate the present value Re[n] of the estimated liquid amount Re. Then, the present value Pw[n] of the wheel pressure Pw is calculated based on the present value Re[n] of the estimated liquid amount Re.

In the estimation calculation of the wheel pressure Pw, the servo pressure Pu may be adopted instead of the supply pressure Pm. In this configuration, the servo pressure sensor is provided to detect the servo pressure Pu (the hydraulic pressure of the servo chamber Ru). Similarly to the above, the previous value Qw[n−1] of the actual flow rate Qw calculated from the servo pressure Pu is time-integrated to calculate the present value Re[n] of the estimated liquid amount Re. Then, the present value Pw[n] of the wheel pressure Pw is estimated based on the present value Re[n] of the estimated liquid amount Re.

In the embodiment described above, the lower braking unit SB (in particular, the lower actuator YB) has been able to increase the supply pressure Pm. Instead, the lower actuator YB may be configured to be able to hold or decrease the supply pressure Pm but not to increase the supply pressure Pm. In this configuration, the control valve UB is omitted from the configuration of FIG. 3. Therefore, the resistance in the lower actuator YB is only the inlet valve VI, and the pressure loss Pd is generated only by the inlet valve VI. Note that in the anti-lock brake control, the wheel pressure Pw is controlled to be less than or equal to the supply pressure Pm, and thus the control valve UB is not necessary for the execution. In addition, in a case where it is necessary to increase the wheel pressure Pw independent of the operation of the braking operation member BP in the sideslip prevention control, the traction control, and the like, the wheel pressure Pw is increased by the upper braking unit SA (in particular, the pressure adjustment unit CA of the upper actuator YA). Therefore, even in the configuration in which the control valve UB is omitted, each-wheel independent control described above is executed without inferiority as compared with the configuration in which the control valve UB is provided.

In the above-described embodiment, the front-rear type is adopted as the two-system braking system. Alternatively, a diagonal type (also referred to as “X type”) may be adopted as the two-system braking system. In this configuration, one of the two master chambers Rm is connected to the left front wheel cylinder and the right rear wheel cylinder, and the other of the two master chambers Rm is connected to the right front wheel cylinder and the left rear wheel cylinder.

In the above-described embodiment, as the pressure adjustment unit CA, the pressure adjustment unit that adjusts the servo pressure Pu by throttling the circulation flow KN of the braking fluid BF discharged from the fluid pump QA by the pressure adjusting valve UA (so-called reflux type configuration) has been exemplified. Alternatively, in the pressure adjustment unit CA, the pressure accumulated in the accumulator may be adjusted by a linear solenoid valve (so-called accumulator-type configuration). In addition, the volume in the cylinder may be increased or decreased by the piston directly driven by the electric motor to adjust the servo pressure Pu (so-called electric cylinder type configuration). Since the output of the electric motor is proportional to the supply current, it is possible to execute feedforward control based on the target pressure Pt and feedback control based on the supply pressure Pm, similarly to the pressure adjusting valve UA.

In the above-described embodiment, the tandem type is exemplified as the master cylinder CM. Instead, a single type master cylinder CM may be adopted. In this configuration, the secondary master piston NS is omitted. Then, one master chamber Rm is connected to the four wheel cylinders CW. In this configuration, the same supply pressures Pmf and Pmr (=Pm) are output from the master cylinder CM.

In the configuration in which the single-type master cylinder CM is adopted, the master chamber Rm may be connected to the front wheel cylinder CWf, and the pressure adjustment unit CA may be directly connected to the rear wheel cylinder CWr. In this configuration, the front wheel supply pressure Pmf is output from the master cylinder CM to the front wheel cylinder CWf as the front-wheel wheel pressure Pwf. On the other hand, the servo pressure Pu is output from the pressure adjustment unit CA to the rear wheel cylinder CWr as the rear wheel supply pressure Pmr.

In the above-described embodiment, in the apply unit AP, the pressure receiving area rm (master area) of the master chamber Rm and the pressure receiving area ru (servo area) of the servo chamber Ru are set equal. The master area rm and the servo area ru may not be equal. In the configuration in which the master area rm and the servo area ru are different, the conversion calculation of the supply pressure Pm and the servo pressure Pu is possible based on the ratio of the servo area ru and the master area rm (i.e., conversion based on “Pm·rm=Pu·ru”).

### SUMMARY OF EMBODIMENTS

The embodiments of the braking control device SC will be summarized. The braking control device SC includes a “pressure adjustment unit CA that adjusts a wheel pressure Pw of a wheel cylinder CW by a servo pressure Pu generated using an electric motor MA as a power source”, “solenoid valves UB and VI provided in a hydraulic pressure transmission path (e.g., the communication path HS) from the servo pressure Pu to the wheel pressure Pw”, and a “controller EA that controls the pressure adjustment unit CA”. The solenoid valve VI (inlet valve) is provided to inhibit an increase in the wheel pressure Pw for anti-lock brake control. Furthermore, the solenoid valve UB (control valve) is provided to increase the wheel pressure Pw from the supply pressure Pm for the sideslip prevention control and the traction control.

When the braking request amount Bs is increased and the hydraulic pressures Pm and Pw are increased, the braking fluid BF flows from the upper braking unit SA toward the wheel cylinder CW. At this time, the flow path of the braking fluid BF is narrowed by the solenoid valves UB and VI. Therefore, the solenoid valves UB and VI become resistances to the flow of the braking fluid BF, and a pressure loss Pd (decrease in hydraulic pressure due to energy loss) occurs.

Hereinafter, the portion where the pressure loss Pd occurs in the path through which the hydraulic pressure is transmitted from the servo pressure Pu to the wheel pressure Pw will be described for each of the four types of exemplified configurations. In the description, a case where the servo pressure Pu and the wheel pressure Pw are increased is shown. Therefore, the braking fluid BF is moved from the pressure adjustment unit CA toward the wheel cylinder CW.

(1) In the configuration in which the servo pressure Pu is transmitted via the piston (NM, etc.) and the control valve UB is provided, the servo pressure Pu electrically generated by the pressure adjustment unit CA is transmitted to the wheel cylinder CW in the order of “Pu→Pm→[UB]→Pq→[VI]→Pw”. Here, [ ] indicates the position of the solenoid valve. The lowering in hydraulic pressure (i.e., the pressure loss Pd) occurs in the control valve UB and the inlet valve VI.

(2) In the configuration in which the servo pressure Pu is transmitted via the piston (NM, etc.) and the control valve UB is omitted, the servo pressure Pu is transmitted to the wheel cylinder CW in the order of “Pu→Pm→[VI]→Pw”. The lowering in hydraulic pressure occurs only in the inlet valve VI.

(3) In the configuration in which the servo pressure Pu is directly supplied to the wheel cylinder CW without interposing the piston or the like and the control valve UB is provided, the servo pressure Pu is transmitted to the wheel cylinder CW in the order of “Pu→[UB]→Pq→[VI]→Pw”. Similarly to the above (1), the lowering in hydraulic pressure occurs in the control valve UB and the inlet valve VI.

(4) In the configuration in which the servo pressure Pu is directly supplied to the wheel cylinder CW without interposing the piston or the like and the control valve UB is omitted, the servo pressure Pu is transmitted to the wheel cylinder CW in the order of “Pu→[VI]→Pw”. Similarly to the above (2), the lowering in hydraulic pressure occurs only in the inlet valve VI.

In the controller EA, the pressure loss Pd in the solenoid valve (VI, etc.) of the lower actuator YB is calculated. Specifically, the instruction pressure Ps is calculated from the braking request amount Bs. The pressure loss Pd is calculated based on the instruction pressure Ps and the wheel pressure Pw. The pressure loss Pd is applied to the instruction pressure Ps to determine the target pressure Pt. That is, the sum of the instruction pressure Ps and the pressure loss Pd is determined as the target pressure Pt in consideration of the component of the pressure loss Pd with respect to the instruction pressure Ps. The pressure adjustment unit CA is controlled based on the target pressure Pt.

Specifically, the pressure loss Pd is calculated by the following method. First, the instruction liquid amount Rs (volume of the braking fluid BF requiring movement to achieve the instruction pressure Ps) is calculated from the instruction pressure Ps. In addition, an actual liquid amount Rw (volume of the braking fluid BF already moved to generate the wheel pressure Pw) is calculated from the wheel pressure Pw. A deviation hRs (instruction amount deviation, volume of the braking fluid BF requiring movement to increase the wheel pressure Pw to the instruction pressure Ps) between the instruction liquid amount Rs and the actual liquid amount Rw is calculated. Then, based on the instruction amount deviation hRs, this is time-differentiated to determine the predicted flow rate Qy. The predicted flow rate Qy is a moving liquid amount per unit time of the braking fluid BF necessary for the wheel pressure Pw to reach the instruction pressure Ps. The pressure loss Pd is determined based on the predicted flow rate Qy so as to increase as the predicted flow rate Qy increases (see equation (1)).

In the braking control device SC, a solenoid valve (at least the inlet valve VI) is disposed in a hydraulic pressure transmission path (e.g., the connection path HS) from the servo pressure Pu to the wheel pressure Pw in order to execute the anti-lock brake control and the like. The solenoid valve corresponds to the control valve UB and the inlet valve VI, and in a configuration in which the control valve UB is omitted, only the inlet valve VI corresponds to the solenoid valve. Even when the solenoid valve is in a fully opened state, the valve opening amount thereof is not sufficiently large. Therefore, when the flow velocity of the braking fluid BF is large to a certain extent, the solenoid valve acts as a resistance to inhibit the flow of the braking fluid BF, and a pressure loss Pd may occur. In the braking control device SC, the influence of the pressure loss Pd is anticipated in the adjustment (i.e., pressure adjusting control) of the servo pressure Pu output from the pressure adjustment unit CA. Therefore, the increase delay of the wheel pressure Pw is avoided, and the pressure increasing responsiveness is improved.

For example, in the pressure adjustment unit CA, the circulation flow KN discharged from the fluid pump QA driven by the electric motor MA is adjusted to the servo pressure Pu by the pressure adjusting valve UA. In the controller EA, the target current It is calculated based on the target pressure Pt, and the supply current Ia of the pressure adjusting valve UA is controlled based on the target current It. Furthermore, in the controller EA, the target rotation speed Nt is calculated based on the target pressure Pt, and control is performed such that the actual rotation speed Na of the electric motor MA matches the target rotation speed Nt. Since the target rotation speed Nt is determined as the minimum value necessary for the pressure adjusting control, power saving of the electric motor MA is achieved in addition to the effect of improving the responsiveness of the wheel pressure Pw.

In the controller EA, the wheel pressure Pw is estimated based on any one of the target pressure Pt, the supply pressure Pm, and the servo pressure Pu. Specifically, in each calculation cycle, the present value Pw[n] of the wheel pressure Pw is estimated based on the previous value Qt[n−1] of the target flow rate Qt calculated from the target pressure Pt. Alternatively, the present value Pw[n] of the wheel pressure Pw is estimated based on the previous value Qw[n−1] of the actual flow rate Qw calculated from the supply pressure Pm or the servo pressure Pu. Since the wheel pressure Pw is estimated, the wheel pressure sensor PW becomes unnecessary. As a result, the configuration of the entire device is simplified.

Since the pressure loss Pd occurs when a rapid increase of the wheel pressure Pw is necessary (i.e., at the time of rapid increase of the braking request amount Bs), the calculation of the pressure loss Pd (i.e., compensation for pressure loss) may be performed only at the time of pressure increase (i.e., when the braking request amount Bs is increased). Therefore, at the time of holding the wheel pressure Pw and at the time of pressure reduction (i.e., when the braking request amount Bs is maintained constant and when the braking request amount Bs is decreased), the calculation of the pressure loss Pd is not performed, and the pressure loss Pd is determined to be “0”. At this time, the target pressure Pt is calculated to be equal to the instruction pressure Ps.

Furthermore, the restriction “the time increase amount dB of the braking request amount Bs is greater than or equal to the predetermined value db” may be applied to the calculation of the pressure loss Pd. That is, when the increase amount dB per unit time of the braking request amount Bs is greater than or equal to the predetermined value db, the pressure loss Pd is added to the instruction pressure Ps to calculate the target pressure Pt. However, when the time increase amount dB is less than the predetermined value db, the pressure loss Pd is set to “0”, and the target pressure Pt is determined to be equal to the instruction pressure Ps. Here, the “predetermined value db” is a constant set in advance.

1. A braking control device for a vehicle comprising:
a pressure adjustment unit that adjusts a wheel pressure of a wheel cylinder by a servo pressure generated using an electric motor as a power source;
a solenoid valve provided in a hydraulic pressure transmission path from the servo pressure to the wheel pressure; and
a controller that controls the pressure adjustment unit; wherein the controller:
calculates a pressure loss in the solenoid valve based on an instruction pressure calculated from a braking request amount and the wheel pressure,
determines a target pressure by adding the pressure loss to the instruction pressure, and
controls the pressure adjustment unit based on the target pressure.

2. The vehicle braking control device for the vehicle according to claim 1, wherein
the controller calculates a predicted flow rate passing through the solenoid valve based on a deviation between an instruction liquid amount calculated from the instruction pressure and an actual liquid amount calculated from the wheel pressure, and calculates the pressure loss based on the predicted flow rate.
